(19) United States
(12) Patent Application Publication
(10) Pub. No.: US 2004/0189877 A1
(43) Pub. Date: Sep. 30, 2004

(54) Apparatus for detecting a common frame in an interlaced image

(76) Inventors: Byung Tae Choi, Anyang-si (KR); Dong Il Han, Seoul (KR)

Correspondence Address: BIRCH STEWART KOLASCH & BIRCH, PO BOX 747, FALLS CHURCH, VA, 22040-0747, US

(21) Appl. No.: 10/751,999

(22) Filed: Jan. 7, 2004

(30) Foreign Application Priority Data
Jan. 8, 2003 (KR) P2003-1035

(51) Int. Cl. H04N 5/14

(52) U.S. Cl. 348/700; 348/448

(57) ABSTRACT

The present invention relates to a digital television, and more particularly, to an apparatus for detecting a common frame in an interlaced image. Since it is determined exactly whether interlaced scanning format fields neighboring in view of time belong to the common frame or different frames, it can be determined more exactly to detect 3:2 pull-down and 2:2 pull-down so that deinterlacing image quality of film mode image is improved.

This application claims the benefit of the Korean Application No. P2003-1035 filed on Jan. 8, 2003, which is hereby incorporated by reference.

### BACKGROUND OF THE INVENTION

1. Field of the Invention

The present invention relates to a digital television, and more particularly, to an apparatus for detecting a common frame in an interlaced image.

2. Discussion of the Related Art

Generally, a television image signal employs an interlaced scanning format of forming one frame by two fields. However, since a personal computer (PC) or a high-definition television (TV) set recently display in a general progressive scanning format, the conventional interlaced scanning format should be converted into the progressive scanning format in order to display the image signal of the interlaced scanning format through the PC or the high-definition television set. This conversion is called “de-interlacing”.

On the other hand, an image source of a movie or a film has basically a progressive scanning format of 24 frames/second. In order to display the image source by using an interlaced scanning display device, the image source should be converted into the interlaced scanning format of 60 fields/second for NSTC and into the interlaced scanning format of 50 fields/second for PAL. Referring to accompanying drawings, detailed description will be made.

FIG. 1A illustrates an image source for a film according to the related art. FIG. 1B illustrates a top field image extracted from the image source for a film of FIG. 1A. FIG. 1C illustrates a bottom field image extracted from the image source for a film of FIG. 1A. FIG. 1D illustrates moved information obtained through a frame detection apparatus according to the related art. Here, as shown in FIGS. 1A to 1B, a 3:2 pull-down method is used to generate an image of the NTSC interlaced scanning format and a 2:2 pull-down method is used to generate an image of the PAL interlaced scanning format.

As shown in FIGS. 1A to 1D, in the 3:2 pull-down method, odd-numbered fields are selected from an original film frame of FIG. 1A to be defined as top fields of FIG. 1B, and even-numbered fields are selected from the original film frame of FIG. 1A to be defined as bottom fields of FIG. 1C. Then, the same top field as FIG. B is added so that fields to be transmitted are generated.

In the 3:2 pull-down method, after only odd-numbered fields are selected from an original film frame of FIG. 1A and defined as top fields of FIG. 1B, and even-numbered fields are selected from the original film frame of FIG. 1A and defined as bottom fields of FIG. 1C, the same top fields as those of FIG. 1B are added to generate fields to be transmitted.

Accordingly, in case an image source of a film has been already converted into the interlaced scanning format, it is more effective to restore original 24-frame data by using field interleaving rather than using general deinterlacing so as to allow the progressive scanning display device to display the restored original 24-frame data, so that better image quality can be obtained especially in case the original 24-frame data has a high frequency region of a lot of motion.

As disclosed in U.S. Pat. Nos. 5,550,592 and 5,291,280, when the conventional film mode detector performs 3:2 pull-down detection, it is easy to detect a common frame by using the fact that the same fields are repeated in interlaced fields as shown in FIGS. 1A to 1D.

When a film mode detector performs 2:2 pull-down detection, in contrast to the 3:2 pull-down detection, it is not easy to detect the common frame since the same fields are repeated in interlaced fields and each frame is divided into a top field and a bottom field.

Here, U.S. Pat. Nos. 5,550,592 and 5,291,280 disclose a motion detector that can determine whether two adjacent fields belong to a common frame even in the case described above.

However, the motion detector works erroneously to a horizontal line of one pixel thickness. In other words, as shown in FIGS. 1A to 1C, when the bottom field is a current field and the motion detector determines whether the bottom field is combined with the top field leading in view of time to restore the common frame, the motion detector obtains the result as shown FIG. 1D and determines that the bottom field cannot be combined with the leading top field to restore the common frame.

### SUMMARY OF THE INVENTION

Accordingly, the present invention is directed to an apparatus for detecting a common frame in an interlaced image, which substantially obviates one or more problems due to limitations and disadvantages of the related art.

An object of the present invention is to provide an apparatus for detecting a common frame in an interlaced image, which determines whether interlaced scanning format fields neighboring in view of time belong to a common frame or different frames.

Another object of the present invention is to provide an apparatus for detecting a common frame in an interlaced image, which determines whether several consecutive field data are a still picture, that is, a motionless image sequence in view of time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for detecting a common frame in an interlaced image includes: a field data provider for sequentially providing a plurality of consecutive field data; at least one motion detector for receiving the field data, detecting motion degrees between fields and between frames, and outputting motion information; at least one pixel motion accumulator for accumulating pixel unit motions obtained by the motion detector to obtain a line unit motion value; at least one line motion filter for vertically filtering the line unit motion value obtained by the pixel motion accumulator; at least one line accumulator for accumulating the line unit motion value filtered by the line motion filter to obtain a field motion value; and a common frame determiner for comparing the motion value between adjacent fields obtained by the line accumulator with a predetermined threshold value.

Here, the motion detector obtains the motion information of previous and next fields with respect to a predetermined location of a field by using an adjacent pixel value in the previous field, an adjacent pixel value in the next field, an adjacent top pixel value in a current field and an adjacent bottom pixel value in a current field.

The common frame determiner compares the motion value between the adjacent fields with the predetermined threshold and determines whether the adjacent fields belong to the common frame according to a predetermined rule.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A illustrates an image source for a film according to the related art;

FIG. 1B illustrates a top field image extracted from the image source for a film of FIG. 1A;

FIG. 1C illustrates a bottom field image extracted from the image source for a film of FIG. 1A;

FIG. 1D illustrates moved information obtained through a frame detection apparatus according to the related art;

FIG. 2 illustrates an apparatus for detecting a common frame in an interlaced image according to the present invention;

FIG. 3 illustrates field and pixel structure used to detect motion according to the present invention;

FIG. 4 illustrates a vertical coordinate and a line motion value to filter line by line according to the present invention.

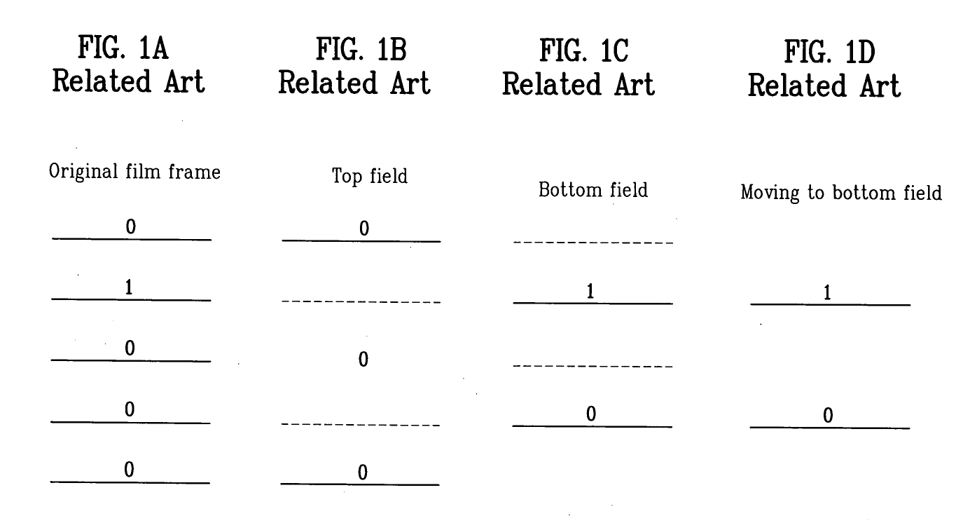

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

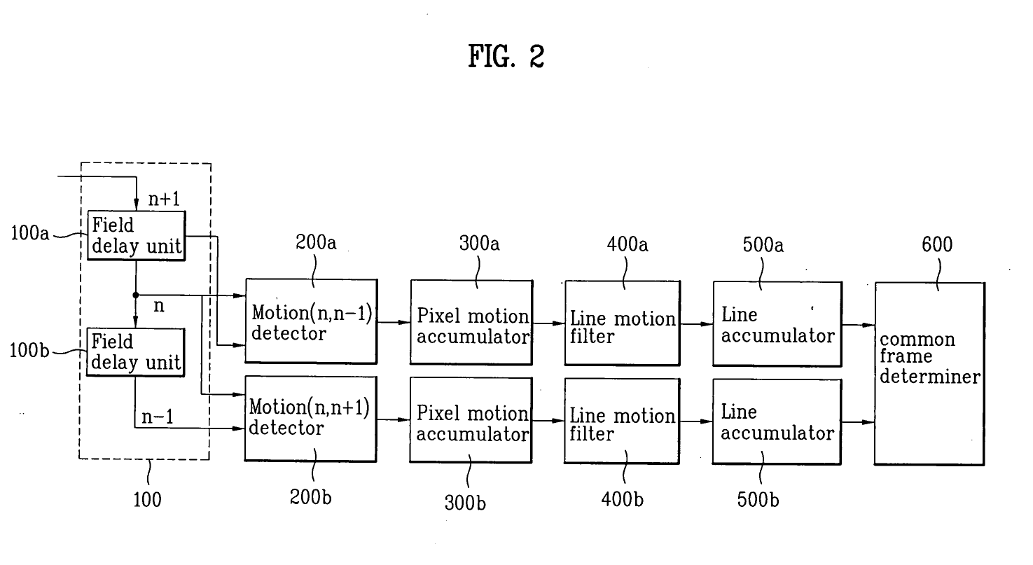

FIG. 2 illustrates an apparatus for detecting a common frame in an interlaced image according to the present invention.

Referring to FIG. 2, the common frame detection apparatus includes a field data provider 100, motion detectors 200a and 200b, pixel motion accumulators 300a and 300b, line motion filters 400a and 400b, line accumulators 500a and 500b and a common frame determiner 600. A field data provider 100 provides a plurality of consecutive field data sequentially. The motion detectors 200a and 200b receive the field data, detect motion degrees between fields and frames, and output motion information. The pixel motion accumulators 300a and 300b accumulate pixel unit motions obtained by the motion detectors 200a and 200b to obtain a line unit motion value. The line motion filters 400a and 400b vertically filter the line unit motion value obtained by the pixel motion accumulators 300a and 300b. The line accumulators 500a and 500b accumulate the line unit motion value filtered by the line motion filters 400a and 400b to obtain a field motion value. The common frame determiner 600 compares the motion values between fields (n−1 and n) and between fields (n and n+1) obtained by the line accumulators 500a and 500b with a predetermined threshold value.

Here, preferably, the field data provider 100 includes a plurality of field delay units 100a and 100 b for sequentially storing image data that are inputted field by field.

The operation of the apparatus for detecting a common frame in an interlaced image according to the present invention will be described in detail referring to accompanying drawings.

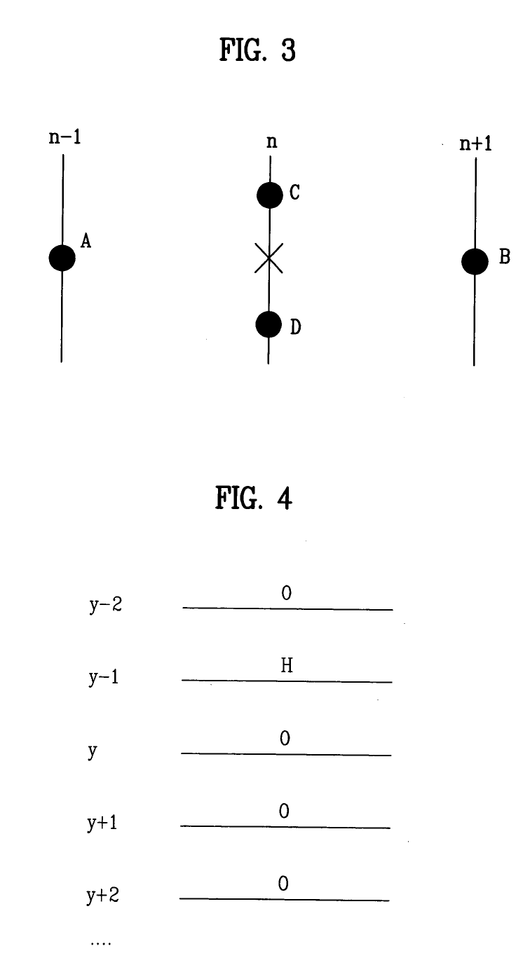

First, the field delay units 100a and 100b store the image data that are inputted field by field. The motion detector 200a receives field unit image data stored in the field delay unit 100a and determines motion between the fields n and n−1. The motion detector 200b receives field unit image data stored in the field delay unit 100b and determines motion between the fields n and n+1. Here, the detection method of the motion detectors 200a and 200b is illustrated in FIG. 3.

In other words, as shown in FIG. 3, the motion detectors 200a and 200b for determining the motion degrees of previous and next fields with respect to the location X of the field n uses equations 1 and 2.

motion(n,n−1,X)=|A−(C+D)/2| Equation 1

motion(n,n+1,X)=|B−(C+D)/2| Equation 2

where A is an adjacent pixel value in a previous field, B is an adjacent pixel value in a next field, C is an adjacent top pixel value in a current field, and D is an adjacent bottom pixel value in a current field.

The pixel values A, B, C and D which are inputted to the motion detectors 200a and 200b can be the pixel values of an image signal that has been filtered by a horizontal low pass filter so as to eliminate noise components that may exist in an real image.

Such motion values are inputted to the pixel motion accumulators 300a and 300b.

The pixel motion accumulators 300a and 300b accumulates the pixel unit motions obtained by the motion detectors 200a and 200b to obtain a line unit motion value. The line motion filters 400a and 400b vertically filter the line unit motion value obtained by the pixel motion accumulators 300a and 300b.

In other words, as shown in FIG. 4, if the line unit motion value is obtained by the pixel motion accumulators 300a and 300b, the line unit motion value is vertically filtered. For example, as the filtering method, a minimum (My, My−1) filter, a minimum (My, My−1, My+1) filter or a median (My, My−1, My+1) filter is used. Here, My represent a motion value in line y, the minimum (My, My−1) filter outputs smaller one of My and My−1, the minimum (My, My−1, My+1) filter outputs smallest one of My, My−1 and My+1, and the median (My, My−1, My+1) filter outputs median one of My, My−1 and My+1 .

The line accumulators 500a and 500b accumulate the line unit motion value filtered by the line motion filters 400a and 400b to output a field motion value.

The common frame determiner 600 compares the motion values between adjacent fields (n−1 and n) and between adjacent fields (n and n+1) with a proper threshold value T and determines whether the consecutive fields can be regarded to belong to the common frame according to a predetermined rule. Here, the determination rule is as follows:

1) if motion (n, n−1)<T and motion (n, n+1)<T, the fields n and n−1 are determined to be a still picture;

2) if motion (n, n−1)<T and motion (n, n+1)>T, the fields n and n−1 are interleaved so that a frame is synthesized since the fields n and n−1 can be determined to belong to a common frame;

3) if motion (n, n−1)>T and motion (n, n+1)<T, the fields n and n+1 are interleaved so that a frame is synthesized since the fields n and n+1 can be determined to belong to a common frame; and

4) if motion (n, n−1)>T and motion (n, n+1)>T, a frame cannot be synthesized since the fields are determined to be different fields.

As described above, if the line unit filter is simply added, more exact motion information between fields can be extracted so that it can be determined more exactly in detecting 3:2 pull-down and 2:2 pull-down.

In addition, motion information between fields can be detected so exactly that film mode deinterlacing is not applied but interleaving can be generally applied without field delay if the fields are determined to belong to a common frame after a pull-down pattern is found over a lot of fields in film mode detection.

When film source image is edited, a film mode detection sequence is stopped and restarted. Here, film mode is applied again after a predetermined field delay is elapsed.

Even in this case, the common frame detection apparatus of the present invention can be used to restore the original film mode image signal without field delay.

The effects of the apparatus for detecting a common frame in an interlaced image according to the present invention as described above are as the followings.

First, since it can be determined more exactly to detect 3:2 pull-down and 2:2 pull-down, deinterlacing image quality of film mode image is improved.

Second, if the adjacent fields are determined to belong to the common frame, interleaving is applied without field delay to obtain more excellent image quality.

Third, if film source image is edited, the film mode detection sequence is stopped and restarted. Here, the same field detector can be applied to restore the original film mode image signal without field delay.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for detecting a common frame in an interlaced image, comprising:
a field data provider for sequentially providing a plurality of consecutive field data;
at least one motion detector for receiving the field data, detecting motion degrees between fields and between frames, and outputting motion information;
at least one pixel motion accumulator for accumulating pixel unit motions obtained by the motion detector to obtain a line unit motion value;
at least one line motion filter for vertically filtering the line unit motion value obtained by the pixel motion accumulator;
at least one line accumulator for accumulating the line unit motion value filtered by the line motion filter to obtain a field motion value; and
a common frame determiner for comparing the motion value between adjacent fields obtained by the line accumulator with a predetermined threshold value.

2. The apparatus of claim 1, wherein the field data provider includes at least two field delay units for sequentially storing image data that are inputted field by field.

3. The apparatus of claim 1, wherein the motion detector obtains the motion information of previous and next fields with respect to a predetermined location of a field by using an adjacent pixel value in the previous field, an adjacent pixel value in the next field, an adjacent top pixel value in a current field and an adjacent bottom pixel value in a current field.

4. The apparatus of claim 1, wherein the line motion filter uses any one of a minimum (My, My−1) filter, a minimum (My, My−1, My+1) filter and a median (My, My−1, My+1) filter,
wherein My represents a motion value in line y,
the minimum (My, My−1) filter outputs smaller one of My and My−1,
the minimum (My, My−1, My+1) filter outputs smallest one of My, My−1 and My+1, and
the median (My, My−1, My+1) filter outputs median one of My, My−1 and My+1.

5. The apparatus of claim 1, wherein the common frame determiner compares the motion value between the adjacent fields with the predetermined threshold value and determines whether the adjacent fields belong to the common frame according to a predetermined rule.

6. The apparatus of claim 5, wherein, in the predetermined rule, if the motion value between the previous field and the current field is less than the threshold value and the motion value between the next field and the current field is less than the threshold value, the fields are determined to be a still picture.

7. The apparatus of claim 5, wherein, in the predetermined rule, if the motion value between the previous field and the current field is greater than the threshold value and the motion value between the next field and the current field is less than the threshold value, the previous field and the current field are determined to belong to a common frame.

8. The apparatus of claim 5, wherein, in the predetermined rule, if the motion value between the previous field and the current field is less than the threshold value and the motion value between the next field and the current field is greater than the threshold value, the previous field and the current field are determined to belong to a common frame.

9. The apparatus of claim 5, wherein, in the predetermined rule, if the motion value between the previous field and the current field is greater than the threshold value and the motion value between the next field and the current field is greater than the threshold value, the previous field and the current field are determined to be different fields.

10. An apparatus for detecting a common frame in an interlaced image, comprising:
a field data provider for sequentially providing a plurality of consecutive field (n−1, n and n+1) data;
at least one motion detector for receiving the field (n−1, n and n+1) data, detecting motion degrees between fields (n−1 and n), between fields (n and n+1) and between frames, and outputting motion information;
at least one pixel motion accumulator for accumulating pixel unit motions obtained by the motion detector to obtain a line unit motion value;
at least one line motion filter for vertically filtering the line unit motion value obtained by the pixel motion accumulator;
at least one line accumulator for accumulating the line unit motion value filtered by the line motion filter to obtain a field motion value; and
a common frame determiner for comparing the motion values between adjacent fields ((n−1 and n) and between adjacent fields (n and n+1)) obtained by the line accumulator with a predetermined threshold value (T) and determining whether the consecutive fields constitute the common frame according to a predetermined rule.

11. The apparatus of claim 10, wherein the motion detector determines motion degrees of the previous field (n−1) and the next field (n+1) with respect to a location X of the field (n) respectively by using following equations:
motion(n, n−1,X)=|A−(C+D)/2|

motion(n, n+1,X)=|B−(C+D)/2|

wherein A is an adjacent pixel value in a previous field,
B is an adjacent pixel value in a next field,
C is an adjacent top pixel value in a current field, and
D is an adjacent bottom pixel value in a current field.

12. The apparatus of claim 11, wherein the pixel values A, B, C and D are pixel values of an image signal that has been filtered by a horizontal low pass filter so as to eliminate noise components that may exist in an real image.

13. The apparatus of claim 10, wherein the common frame determiner compares the motion value between the previous field (n−1) and the next field (n+1) with the predetermined threshold value and determines whether the fields (n−1 and n+1) belong to the common frame according to a predetermined rule.

14. The apparatus of claim 13, wherein, in the predetermined rule, if motion (n, n−1)<T and motion (n, n+1)<T, the fields (n and n−1) are determined to be a still picture;
if motion (n, n−1)<T and motion (n, n+1)>T, the fields (n and n−1) are determined to belong to a common frame;
if motion (n, n−1)>T and motion (n, n+1)<T, the fields are determined to belong to a common frame; and
if motion (n, n−1)>T and motion (n, n+1)>T, the fields are determined to be different fields.
